(19) United States
(12) Patent Application Publication
(10) Pub. No.: US 2019/0205776 A1
(43) Pub. Date: Jul. 4, 2019

(54) TECHNIQUES FOR POLICY-CONTROLLED ANALYTIC DATA COLLECTION IN LARGE-SCALE SYSTEMS

(71) Applicant: Telefonaktiebolaget LM Ericsson (Publ), Stockholm (SE)

(72) Inventors: James KEMPF, Mountain View, CA (US); Julien FORGEAT, San Jose, CA (US); Joacim HALEN, Sollentuna (SE)

(21) Appl. No.: 16/331,518

(22) PCT Filed: Sep. 9, 2016
(86) PCT No.: PCT/IB2016/055407

§ 371 Date: Mar. 7, 2019

(51) Int. Cl. G06N 5/04

(52) U.S. Cl. CPC G06N 5/046

(57) ABSTRACT

Exemplary techniques for policy-controlled analytic data collection in large-scale systems are described. A policy engine receives predicate/action pairs and an alerts policy, each predicate identifying an operating condition at a reporting module that can be evaluated as true or false, and a corresponding action identifying what the reporting module is to do upon the corresponding predicate being evaluated as true. The policy engine provides the predicate/action pairs to reporting modules to be installed as rules, which generate analytic data vectors and apply those vectors against the rules. The actions may cause the reporting modules to send the analytic data vectors as analytic report data to an analytics engine, which has been configured with the alerts policy received by the policy engine. The analytics engine applies received analytic report data against the alerts policy to determine whether to send alert event data to the policy engine or to perform a responsive action.

### TECHNICAL FIELD

Embodiments of the invention relate to the field of computing systems; and more specifically, to techniques for policy-controlled analytic data collection in large-scale systems.

### BACKGROUND

With the advent of large-scale machine intelligence, the ability to almost completely automate the management of cloud and/or network services based upon the analysis of data has entered the realm of the conceivable. To make this capability a reality, however, data from such services must be analyzed in real time, which has been referred to as “stream analytics.” However, scaling stream analytics for services provided to end users is particularly problematic because a particular service may have millions of end users, and thus achieving real time, scalable, and cost effective performance for stream analytics with such huge volumes of data is tremendously difficult. Moreover, there are also areas other than end user services where the collection of streaming data and real time analysis is difficult, such as in machine-to-machine communications involving large numbers of vehicles, or in high speed network devices where the problem isn't the data volume so much as the need for a very quick response in very specific circumstances.

Further complicating matters is that on the front end, business decision makers typically express high level policies that are to be implemented in a declarative manner, and there is no standard method to translate such declarative statements into specific imperative policy constraints on the various information and communication technology (ICT) subsystems (e.g., cloud, network, etc.) that can then guide the analytics and management systems. Instead, most development in this regard has attempted to solve these problems with error-prone and slow-to-deploy ad hoc systems and scripting.

Accordingly, there is a substantial need for systems that can flexibly implement a variety of policies in large-scale systems while still enabling real-time (or near real-time) stream analytics.

### SUMMARY

Systems, methods, apparatuses, computer program products, and machine-readable media are provided for policy-controlled analytic data collection in large-scale systems.

According to some embodiments, an exemplary method is performed by a reporting module implemented by a device for enabling a service performance issue to be detected via policy-controlled analytic data collection. The method includes obtaining, by the reporting module from a policy engine, one or more messages carrying domain rule data that identifies, for each of one or more domain rules, one or more predicates and one or more actions. Each of the one or more predicates identifies an operating condition of the reporting module that can be evaluated by the reporting module as being either true or false, and each of the one or more actions corresponds to at least one of the one or more predicates and identifies what the reporting module is to do upon a corresponding predicate being evaluated as being true. The method further includes configuring, by the reporting module using the obtained domain rule data, one or more rules of a rule table to correspond to the one or more domain rules. Each of the one or more rules includes the one or more predicates and the one or more actions. The method further includes, responsive to an evaluation that the one or more predicates of a first rule of the one or more rules is true based upon one or more values of an analytic data vector, transmitting, by the reporting module, the analytic data vector as analytic report data to an analytics engine due to one of the one or more actions of the first rule, whereby the analytics engine can analyze the analytic report data along with one or more other analytic report data provided by one or more other reporting modules to determine whether to send an event data to the policy engine indicating that the service performance issue is detected.

In some embodiments, the method further includes generating the analytic data vector. In some embodiments, the method further includes, after a threshold amount of time, generating a second analytic data vector, and responsive to an evaluation that at least one of the one or more predicates of the first rule is false, evaluating another one or more predicates of a second rule of the one or more rules. In some embodiments, the method further includes, responsive to the another one or more predicates of the second rule being evaluated as true, transmitting the second analytic data vector as second analytic report data to the analytics engine. In some embodiments, responsive to at least one of the another one or more predicates of the second rule being evaluated as false, the method further includes evaluating the one or more predicates of each additional rule of the one or more rules that has not yet been evaluated, and responsive to one or more evaluations that at least one of the one or more predicates of each additional rule is false, performing a default action.

In some embodiments, the default action is identified within the domain rule data, and the default action is not associated with any of the one or more rules. In some embodiments, the default action comprises causing the second analytic data vector to be stored by a non-volatile storage.

In some embodiments, the device is a media player, and the service comprises an Internet Protocol (IP) television service.

According to some embodiments, a non-transitory machine-readable storage medium has instructions which, when executed by one or more processors of a device, cause the device to implement a reporting module to implement policy-controlled analytic data collection to enable a service performance issue to be detected by performing operations. The operations include obtaining, from a policy engine, one or more messages carrying domain rule data that identifies, for each of one or more domain rules, one or more predicates and one or more actions. Each of the one or more predicates identifies an operating condition of the reporting module that can be evaluated by the reporting module as being either true or false, and each of the one or more actions corresponds to at least one of the one or more predicates and identifies what the reporting module is to do upon a corresponding predicate being evaluated as being true. The operations further include configuring, using the obtained domain rule data, one or more rules of a rule table to correspond to the one or more domain rules. Each of the one or more rules includes the one or more predicates and the one or more actions. The operations further include, responsive to an evaluation that the one or more predicates of a first rule of the one or more rules is true based upon one or more values of an analytic data vector, transmitting the analytic data vector as analytic report data to an analytics engine due to one of the one or more actions of the first rule, whereby the analytics engine can analyze the analytic report data along with one or more other analytic report data provided by one or more other reporting modules to determine whether to send an event data to the policy engine indicating that the service performance issue is detected.

According to some embodiments, a computer program product has computer program logic arranged to implement a reporting module to implement policy-controlled analytic data collection to enable a service performance issue to be detected by performing operations. The operations include obtaining, from a policy engine, one or more messages carrying domain rule data that identifies, for each of one or more domain rules, one or more predicates and one or more actions. Each of the one or more predicates identifies an operating condition of the reporting module that can be evaluated by the reporting module as being either true or false, and each of the one or more actions corresponds to at least one of the one or more predicates and identifies what the reporting module is to do upon a corresponding predicate being evaluated as being true. The operations further include configuring, using the obtained domain rule data, one or more rules of a rule table to correspond to the one or more domain rules. Each of the one or more rules includes the one or more predicates and the one or more actions. The operations further include, responsive to an evaluation that the one or more predicates of a first rule of the one or more rules is true based upon one or more values of an analytic data vector, transmitting the analytic data vector as analytic report data to an analytics engine due to one of the one or more actions of the first rule, whereby the analytics engine can analyze the analytic report data along with one or more other analytic report data provided by one or more other reporting modules to determine whether to send an event data to the policy engine indicating that the service performance issue is detected.

According to some embodiments, a device includes one or more processors and a non-transitory machine-readable storage medium. The non-transitory machine-readable storage medium has instructions which, when executed by the one or more processors, cause the device to implement a reporting module to implement policy-controlled analytic data collection to enable a service performance issue to be detected by performing operations. The operations include obtaining, from a policy engine, one or more messages carrying domain rule data that identifies, for each of one or more domain rules, one or more predicates and one or more actions. Each of the one or more predicates identifies an operating condition of the reporting module that can be evaluated by the reporting module as being either true or false, and each of the one or more actions corresponds to at least one of the one or more predicates and identifies what the reporting module is to do upon a corresponding predicate being evaluated as being true. The operations further include configuring, using the obtained domain rule data, one or more rules of a rule table to correspond to the one or more domain rules. Each of the one or more rules includes the one or more predicates and the one or more actions. The operations further include, responsive to an evaluation that the one or more predicates of a first rule of the one or more rules is true based upon one or more values of an analytic data vector, transmitting the analytic data vector as analytic report data to an analytics engine due to one of the one or more actions of the first rule, whereby the analytics engine can analyze the analytic report data along with one or more other analytic report data provided by one or more other reporting modules to determine whether to send an event data to the policy engine indicating that the service performance issue is detected.

According to some embodiments, a device includes a module adapted to implement a reporting module to enable a service performance issue to be detected via policy-controlled analytic data collection. The reporting module is to obtain, from a policy engine, one or more messages carrying domain rule data that identifies, for each of one or more domain rules, one or more predicates and one or more actions. Each of the one or more predicates identifies an operating condition of the reporting module that can be evaluated by the reporting module as being either true or false. Each of the one or more actions corresponds to at least one of the one or more predicates and identifies what the reporting module is to do upon a corresponding predicate being evaluated as being true. The reporting module is also to configure, using the obtained domain rule data, one or more rules of a rule table to correspond to the one or more domain rules. Each of the one or more rules includes the one or more predicates and the one or more actions. The reporting module is also to, responsive to an evaluation that the one or more predicates of a first rule of the one or more rules is true based upon one or more values of an analytic data vector, transmit the analytic data vector as analytic report data to an analytics engine due to one of the one or more actions of the first rule, whereby the analytics engine can analyze the analytic report data along with one or more other analytic report data provided by one or more other reporting modules to determine whether to send an event data to the policy engine indicating that the service performance issue is detected.

According to some embodiments, a device to implement a reporting module to enable a service performance issue to be detected via policy-controlled analytic data collection comprises a module to obtain, from a policy engine, one or more messages carrying domain rule data that identifies, for each of one or more domain rules, one or more predicates and one or more actions. Each of the one or more predicates identifies an operating condition of the reporting module that can be evaluated by the reporting module as being either true or false. Each of the one or more actions corresponds to at least one of the one or more predicates and identifies what the reporting module is to do upon a corresponding predicate being evaluated as being true. The device further comprises a module to configure, using the obtained domain rule data, one or more rules of a rule table to correspond to the one or more domain rules. Each of the one or more rules includes the one or more predicates and the one or more actions. The device further comprises a module to, responsive to an evaluation that the one or more predicates of a first rule of the one or more rules is true based upon one or more values of an analytic data vector, transmit the analytic data vector as analytic report data to an analytics engine due to one of the one or more actions of the first rule, whereby the analytics engine can analyze the analytic report data along with one or more other analytic report data provided by one or more other reporting modules to determine whether to send an event data to the policy engine indicating that the service performance issue is detected.

According to some embodiments, a system that enables a service performance issue to be detected via policy-controlled analytic data collection includes a policy engine implemented by a first device, an analytics engine implemented by a second device, and a plurality of reporting modules implemented by a corresponding plurality of devices. The policy engine receives an alerts policy and one or more predicate-action pairs, provides the alerts policy to the analytics engine, and provides domain rule data comprising the one or more predicate-action pairs to each of the plurality of reporting modules. Each of the plurality of reporting modules configures a rule table that is local to the reporting module to include rules based upon the one or more received predicate-action pairs. Each rule includes one or more predicates and one or more corresponding actions to be performed by the reporting module when the one or more predicates evaluate to true. Each of the plurality of reporting modules also generates analytic data vectors based upon current characteristics of the device implementing the reporting module, and transmits, to the analytics engine, one of the analytic data vectors as analytic report data when the one or more predicates of one of the rules evaluate to true based upon the one analytic data vector. The analytics engine receives those of the analytic report data that have been transmitted by corresponding ones of the plurality of reporting modules, and analyzes those received analytic report data using the alerts policy to determine when to transmit an event data to the policy engine indicating that the service performance issue is detected.

Some disclosed embodiments can flexibly implement a variety of policies in large-scale systems while still enabling real-time (or near real-time) stream analytics. Moreover, some embodiments can simplify the process of establishing a mapping between human understandable business rules and low level policy rules and events that could result in violations of the policy, which can allow decision makers to limit the values of analytic data to be collected without having to directly specify what those particular values are. Some embodiments can reduce the volume of data forwarded towards the analytics engine, allowing the analytics engine to perform real time stream analytics at a very reasonable cost in terms of time, processing, and/or storage overhead. Further, the data that is forwarded may also be more relevant to the analytics process, which is oriented toward coming up with an indication of an event requiring attention from the policy system. Thus, when the data at the source is not indicating a developing problem, then there is little or no point in forwarding it, so in some embodiments the rules installed at each collection point can thus effectively pre-filter the data according to policy specific constraints.

### BRIEF DESCRIPTION OF THE DRAWINGS

The invention may best be understood by referring to the following description and accompanying drawings that are used to illustrate embodiments of the invention. In the drawings:

FIG. 1 is a high level block diagram illustrating a system for policy-controlled analytic data collection in large-scale systems according to some embodiments.

FIG. 2 is a combined sequence and flow diagram illustrating operations for policy-controlled analytic data collection in large-scale systems according to some embodiments.

FIG. 3 is a flow diagram illustrating exemplary operations for utilizing configured rule tables with an analytic data vector according to some embodiments.

FIG. 4 illustrates an exemplary rule installed in a rule table, an exemplary analytic data vector sent from a reporting module to an analytics engine, and an exemplary alerts policy installed at an analytics engine according to some embodiments.

FIG. 5 is a flow diagram illustrating a flow for policy-controlled analytic data collection in large-scale systems according to some embodiments.

FIG. 6A illustrates connectivity between network devices (NDs) within an exemplary network, as well as three exemplary implementations of the NDs, according to some embodiments.

FIG. 6B illustrates an exemplary way to implement a special-purpose network device according to some embodiments of the invention.

### DETAILED DESCRIPTION

The following description relates to the field of computing systems, and more specifically, describes methods, systems, apparatuses, computer program products, and machine-readable media for policy-controlled analytic data collection in large-scale systems.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

Existing approaches to large-scale data analytics typically involve collecting large amounts of data and depositing it in a database for a later delayed analysis (which could be seconds, minutes, hours, or days later in time), or by periodically sampling data at the source according to some statistical distribution to avoid incurring the collection of large volumes of data.

However, using a database and delayed analysis incurs a significant risk that the system may experience a fault that is not detected for a potentially intolerable amount of time, whether it is seconds, minutes, hours, etc., until the analytics system catches up with the data collection. Further by taking only periodic samples of data, such systems often miss transient error conditions when the duration of the condition is less than the sampling period.

An example of the aforementioned necessary trade-off can be seen in the Collectd metrics storage configuration. Collectd is a widely used open source metrics collection framework that typically stores its metrics in something called “RRD” files. In order to reduce file system Input/Output (I/O) when the amount of collected metrics is high, Collectd metrics are cached and written in bulk into these files. To this end, Collectd employs a “CacheFlush” setting that controls how often the data is guaranteed to be written. The CacheFlush default value is 120 seconds, which means that downstream applications will be up to 2 minutes behind.

Further, as introduced above, on the front end a wide array of ad hoc techniques are used to communicate policy between business decision makers and the technical people responsible for translating them into ICT policy rules, and it is very difficult to perform these translations and adapt the underlying large-scale analytics infrastructure to accommodate these often changing needs.

Accordingly, embodiments disclosed herein utilize techniques for policy-controlled analytic data collection in large-scale systems. In some embodiments, a collection of policy rules for analytics data collection and a collection of event descriptions are provided to a policy engine and an analytics engine, respectively. The collection of policy rules for analytics data collection and the collection of event descriptions can be translated by domain experts from high level declarative polices. The collection of policy rules can thereby place constraints onto the analytic data collection that is performed, and the collection of event descriptions can indicate when a potential error or malfunction condition should be signaled.

On the back end, embodiments can install a policy-controlled filter into each of the involved data collection points (or “reporting modules”, such as an end user device, network equipment, etc.) so that the collection point only forwards data to the analytics system when the data indicate that the service is moving outside of policy-specified control boundaries. In some embodiments, the filter comprises a table, the columns of which are rule-action pairs, where the rule column value specifies a logical predicate that matches against certain of the measured parameters, and the action column value specifies an action to be performed for the data value (e.g., how the data value should be disposed of) when the corresponding rule matches as true. Accordingly, in some embodiments this can result in data being forwarded by the collection points to the analytics system only when, at a collection point, the data indicates that the service is moving outside of policy specified control boundaries, thus significantly reducing the amount of data that needs to be transmitted by the collection points and collected and processed by the analytics system.

Accordingly, embodiments can simplify the process of establishing a mapping between human understandable business rules and low level policy rules and events that could result in violations of the policy. The translation of business rules to low level predicates can allow decision makers to limit the values of analytic data to be collected without having to directly specify what those particular values are. Accordingly, embodiments can reduce the volume of data forwarded towards the analytics engine, allowing the analytics engine to perform real time stream analytics at a very reasonable cost in terms of time, processing, and/or storage overhead. Further, the data that is forwarded may also be more relevant to the analytics process, which is oriented toward coming up with an indication of an event requiring attention from the policy system. Thus, when the data at the source is not indicating a developing problem, then there is little or no point in forwarding it, so in some embodiments the rules installed at each collection point can thus effectively pre-filter the data according to policy specific constraints.

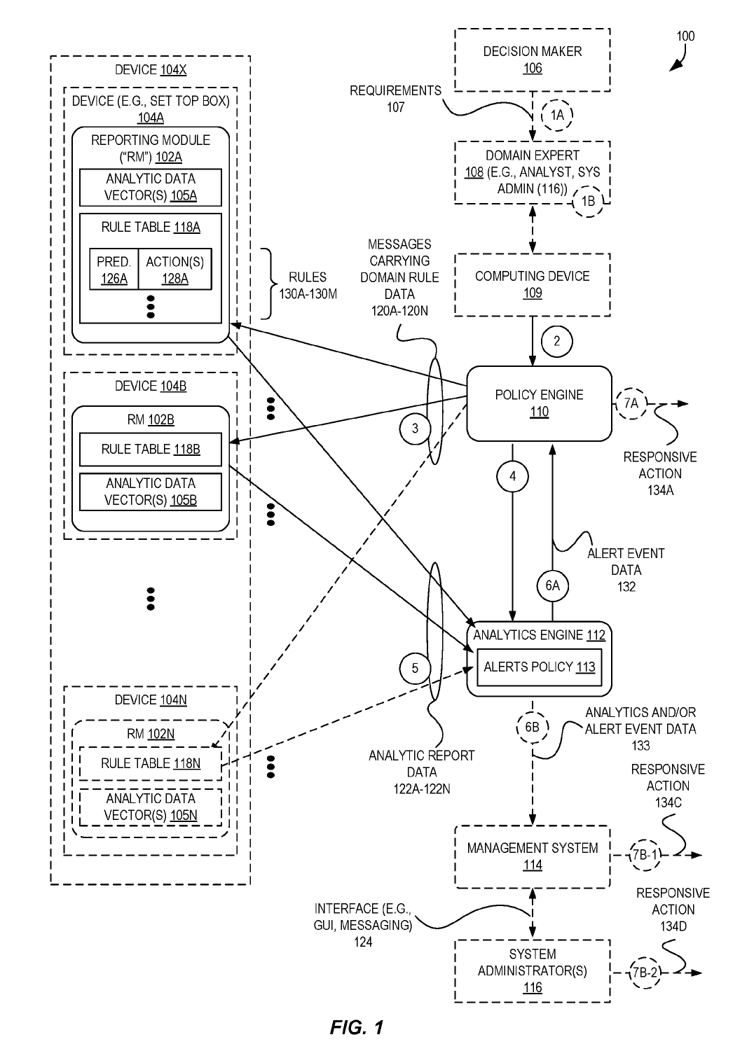

FIG. 1 is a high level block diagram illustrating policy-controlled analytic data collection in a large-scale system 100 according to some embodiments. The illustrated system 100 includes a policy engine 110, an analytics engine 112, and a plurality of reporting modules (“RMs”) 102A-102N implemented by one or more devices 104.

In some embodiments, there can be tens, hundreds, thousands, tens of thousands, or more reporting modules 102, each of which may or may not be associated with a unique device 104. Thus, a single reporting module 102A may be implemented at a single device 104A (and perhaps a second single reporting module 102B implemented at a second single device 104B, and so on), or two or more reporting modules 102A-102N could be implemented at a single device 104X.

By way of example, the reporting modules 102 could be part of many different types of devices and report back various types of data. As one example, the reporting modules 102 could be part of set-top boxes, mobile devices, or smart televisions operating as part of an Internet Protocol Television (IPTV) system providing an audiovisual media service (e.g., streaming audiovisual content, etc.) to subscribers, where the reporting modules 102 could report back playback performance data, operating conditions, etc. As another example, the reporting modules 102 could be part of various sensors, such as sensors within automobiles or other vehicles reporting location/performance/etc. data, sensors embedded within consumer devices reporting conditions at (or of) those devices, sensors utilized in farming or other agricultural or biological settings reporting environmental data, etc.

Optionally beginning at circle ‘1A’, a decision maker 106 may provide a set of requirements 107 comprising a declarative policy to a domain expert 108 such as an analyst or system administrator 116. The set of requirements 107 may be based upon technical (and/or business) considerations, and may be relatively high level. For example, in an IPTV system, a declarative policy of a set of requirements 107 could be a “reduced streaming video quality” declarative policy to “Ensure that no more than 10% of the video-on-demand (VOD) users are experiencing reduced streaming video quality.” This declarative policy may be based upon criteria such as the percentage of users who are likely to call customer service (and thereby incur costs to the service provider) when the quality of the offered IPTV service degrades, or the percentage of users who are likely to cancel their service due to such problems occurring.

The domain expert 108 may then, at circle ‘1B’, translate the declarative policy of the set of requirements 107 into a collection of low-level domain policy rule/action pairs (to be installed by RMs 102A-102N as rules 130A-130M) for analytics data collection and also into an alerts policy 113 for an analytics engine 112.

For example, to continue the IPTV system scenario presented above, the domain expert 108 may translate the “reduced streaming video quality” declarative policy into specific policy rules 130A-130M containing predicates 126 on the underlying measured video at the service endpoints/devices 104A-104N, and instructions to the analytics engine (i.e., an alerts policy 113) indicating when to generate alert event data (i.e., event data 132) directed to the policy engine 110.

The predicates 126 of the rules 130A-130M can include constraints on the analytic data vectors (i.e., analytic report data 122A-122N) provided by the reporting modules 102A-120N. If the predicate is matched, an associated action is performed. For example, the following rule (e.g., rule 130A) may be generated by the domain expert 108 based upon the declarative policy:

Predicate (126A): IF ((jitter >120 ms) OR (bitrate <4.5 Mbps))

Action(s) (128A): THEN forward analytic data vector to analytics engine ELSE forward analytic data vector to cold storage

As shown above, the example rule includes two actions—one if the predicate is satisfied (i.e., forward analytic data vector to analytics engine) and one if the predicate is not satisfied (i.e., forward analytic data vector to cold storage). In some embodiments, there can be one or more actions that can be performed when a predicate is satisfied, and in some embodiments there can be zero, one, or more actions that can be performed when the rule's predicate is not satisfied.

Additionally, the domain expert 108 may generate the following alert policy 113 based upon the declarative policy:

Generate alert event data and send towards Policy Engine when (10% or more of users report jitter >150 ms) OR (10% or more of users report bitrate <4 Mbps)

Per the above, the analytic data vector is sent to cold storage (e.g., a hard disk) if the analytics engine 112 doesn't need it, and the domain expert 108 has left a margin in the values of the collection parameters to avoid a sudden deterioration in the video quality beyond what the decision maker's 106 policy has specified as the lower limit. Additionally, while many of the actions utilized in some scenarios may involve forwarding analytic data to the analytics engine 112, other actions are possible, for example, performing some local action to improve service delivery.

As illustrated, the domain expert 108 may utilize a computing device 109 (e.g., a client end station, a server end station, etc.) to perform the translation of the declarative policy of the set of requirements 107 into a collection of low-level domain policy rule/action pairs and the alerts policy 113, or may simply utilize a computing device 109 to input the collection of low-level domain policy rule/action pairs and the alerts policy 113 (e.g., using I/O devices such as a keyboard, mouse, microphone, etc.).

At circle ‘2’, the collection of low-level domain policy rule/action pairs and the alerts policy 113 can be provided to policy engine 110. Although not illustrated, optionally the alerts policy 113 can be directly provided to the analytics engine 112 by the computing device 109, which may instead provide just the low-level domain policy rule/action pair information to the policy engine 110.

At circle ‘3’, the policy engine 110 may, by transmitting messages carrying domain rule data 120A-120N, cause the configuration of the rule tables 118A-118N (or “rule/action filters”) in the reporting modules 102A-102N of the device(s) 104 with rules 130A-130M with predicates 126A-126N that break down the high level policy into specific constraints on the collection of analytic data.

Additionally, in some embodiments when a new service endpoint/device (e.g., device 104A) becomes operational (e.g., is turned on or is otherwise added to the system), the policy engine 110 may install the collection of rule/action pairs (i.e., rules 130A-130M) into the rule table 118A of that device by transmitting similar messages 120.

During operation of the service endpoint/device (e.g., device 104A), a time series of analytic data vectors may be generated. An analytic data vector, in some embodiments, is a collection of values describing one or more conditions that are present (or observed) by the reporting modules 102 (and/or the device(s) 104 upon which the reporting modules 102 are located). In some embodiments, the reporting modules 102 (and/or devices 104) are configured to, according to a schedule, periodically generate an analytic data vector.

When an analytic data vector is generated, the individual parameters may be logically “inserted” into the predicates 126 of the rule table 118, e.g., starting with the first predicate in the table. In this manner, one or more of the rules can be evaluated. When a predicate 126A evaluates as true, the associated action(s) 128A are taken. Thus, in some embodiments, upon obtaining/generating an analytic data vector, the reporting module 102A may determine whether the predicate(s) 126 of its one or more installed rules 130A-130M are satisfied, and when a generated/obtained analytic data vector satisfies a rule, the corresponding action(s) 128A are triggered.

In some embodiments, when no predicate 126A in the rule table 118A is matched, a default action may be taken. For example, a default action may comprise “dropping” the analytic data vector, sending the analytic data vector to a cold storage database, etc. In some embodiments, when a predicate of a rule is matched, no other rules will be evaluated, but in other embodiments, all or a subset of the rules may be evaluated regardless, which can result in zero, one, or more than one rules being matched. Thus, it is possible in some embodiments that the action(s) 128A of more than one rule may be performed for a particular analytic data vector. In some embodiments (e.g., such as in the former case when a predicate of a rule is matched and no other rules will be evaluated), the order in which predicates 126 are evaluated to determine if they are true or false may be pre-determined, for example, according to a particular priority as determined by the decision maker 106 or the domain expert 108.

At circle ‘4’, the policy engine 110 configures the analytics engine 112 with the alerts policy 113 specifying when an alert should be triggered. Continuing the example, the alerts policy 113 may indicate that the analytics engine 112 is to generate alert event data for sending towards policy engine 110 when either 10% or more of the users/devices report a jitter of greater than 150 milliseconds or when 10% or more of users/devices report a bit rate of less than 4 Megabits per second.

Notably, this example shows that the rules 130 installed in the reporting modules 102 may be more broad than the corresponding alerts policy 113, as the reporting modules 102 will start reporting analytic data vectors when they observe a jitter greater than 120 ms or a bitrate less than 4.5 Mbps, while the analytics engine 112 will generate an alert (e.g., event data 132) when it observes 10% of the users/devices reporting a jitter greater than 150 ms or a bit rate of less than 4 Mbps. In embodiments using such a configuration, this “early” reporting of analytic data vectors can provide extra data to the analytics engine for analytics purposes (e.g., observing how the problems ramped up over time), for example.

Thereafter, the reporting modules 102 may begin to operate by generating analytics data vectors and evaluating predicates of rules, thus “filtering” the analytics data vectors so that only “interesting” analytics data vectors are reported to the analytics engine 112, thereby reducing the load/strain on its resources (as it does not need to process analytic data vectors that are non-problematic) and the utilization of the network there between.

At the analytics engine 112, when an alerts policy 113 is triggered (i.e., its rule is satisfied based upon one or more analytic data vectors satisfying its predicate(s)), the analytics engine 112 can send an alert event data 132 to the policy engine 110 at circle ‘6A’, which may then determine what control actions are required and perform a responsive action 134A at circle ‘7A’.

In some embodiments, the analytics engine 112 may also send analytics and/or alert event data 133 (at circle ‘6B’) to a management system 114, which may perform a responsive action 134C (at circle ‘7B-1’), and/or provide a service/network dashboard data via an interface 124 (e.g., a graphical user interface (GUI), electronic message, etc.) for display to human users (e.g., system administrator(s) 116), who then may perform a responsive action 134D at circle ‘7B-2’.

The responsive actions 134 can include any number of actions, including but not limited to notifying particular users/individuals (via one or more interfaces) of the alerts policy violation, re-configuring certain devices/entities involved in the service (e.g., one or more of the devices 104A-104N, another device sending data for the service, etc.) perhaps to attempt to fix a problem indicated by the violation of the alerts policy, etc.

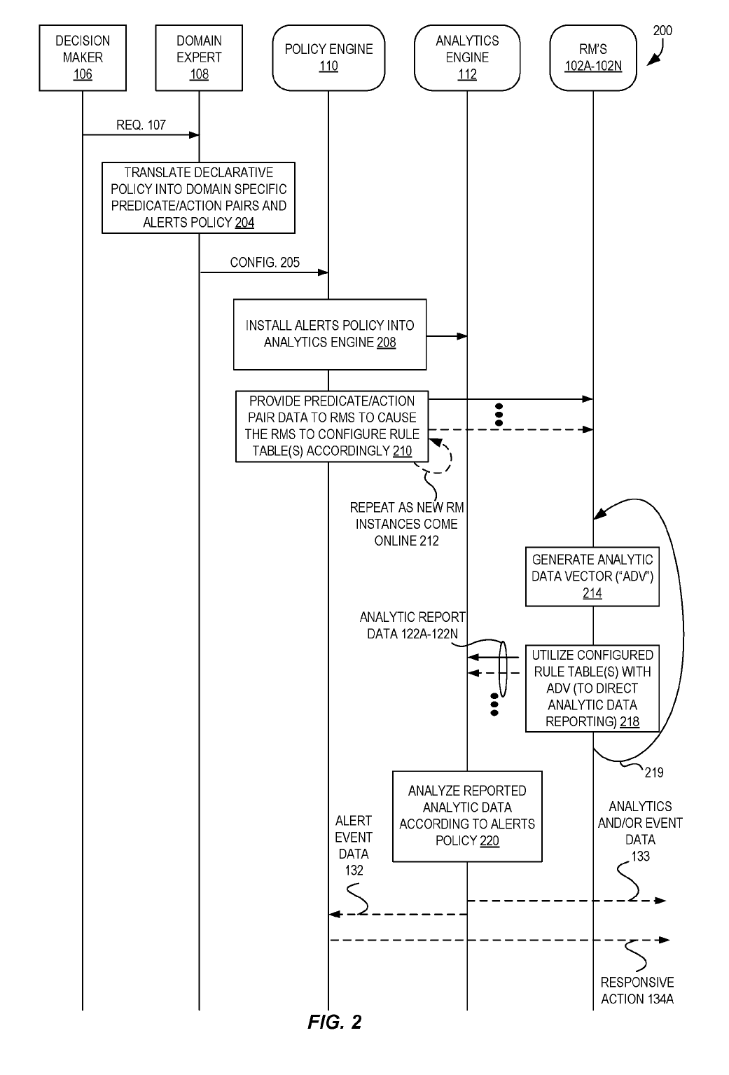

For further detail, FIG. 2 is a combined sequence and flow diagram illustrating operations 200 for policy-controlled analytic data collection in large-scale systems according to some embodiments. FIG. 2 includes a decision maker 106, a domain expert 108, a policy engine 110, an analytics engine 112, and one or more reporting modules 102 (collectively as RMs 102A-102N), though it is to be understood that in other embodiments not all of these entities need to exist or perform these illustrative operations.

In this figure, the decision maker 106 provides a set of requirements 107 to the domain expert 108, which can include a declarative policy as described herein. The domain expert 108, at block 204, can translate the declarative policy into one or more domain-specific predicate/action pairs (for a corresponding one or more rules) and one or more alert policies, and provide configuration data 205 (including the one or more domain-specific predicate/action pairs and one or more alert policies) to policy engine 110.

At block 208, the policy engine 110 can install the one or more alerts policies into the analytics engine 112, which can include transmitting a message including the one or more alerts policies to the analytics engine 112, where the message can include an identifier serving as a command to the analytics engine 112 to install the one or more alerts policies.

At block 210, the policy engine 110 can provide the predicate/action pair data to one or more reporting modules 102A-102N, causing the reporting module(s) 102A-102N to configure their rule table(s) 118 to reflect the one or more predicate/action pairs with rules. This block 210 may occur one or more times (see 212), such as when a new reporting module 102 instance comes online, changes its account/service/physical configuration, reboots, etc.

Of course, blocks 208 and 210 may be performed in a different order in different embodiments, at different times, repeatedly, etc.

At some point, each of the one or more reporting modules 102A-102N generates an analytic data vector (or “ADV”) 214. The one or more reporting modules 102A-102N may be configured to perform block 214 (and similarly, block 218) according to a schedule, which may be periodic (i.e., occurring at regular intervals), non-periodic (i.e., occurring at non-regular intervals), or combinations of both.

At block 218, which can occur after each occurrence of block 214 by a particular reporting module 102, the reporting module 102 can utilize its configured rule table 118 with the generated analytic data vector, to determine which, if any, predicates match and accordingly, which, if any, actions should be performed with (or based upon) the analytic data vector.

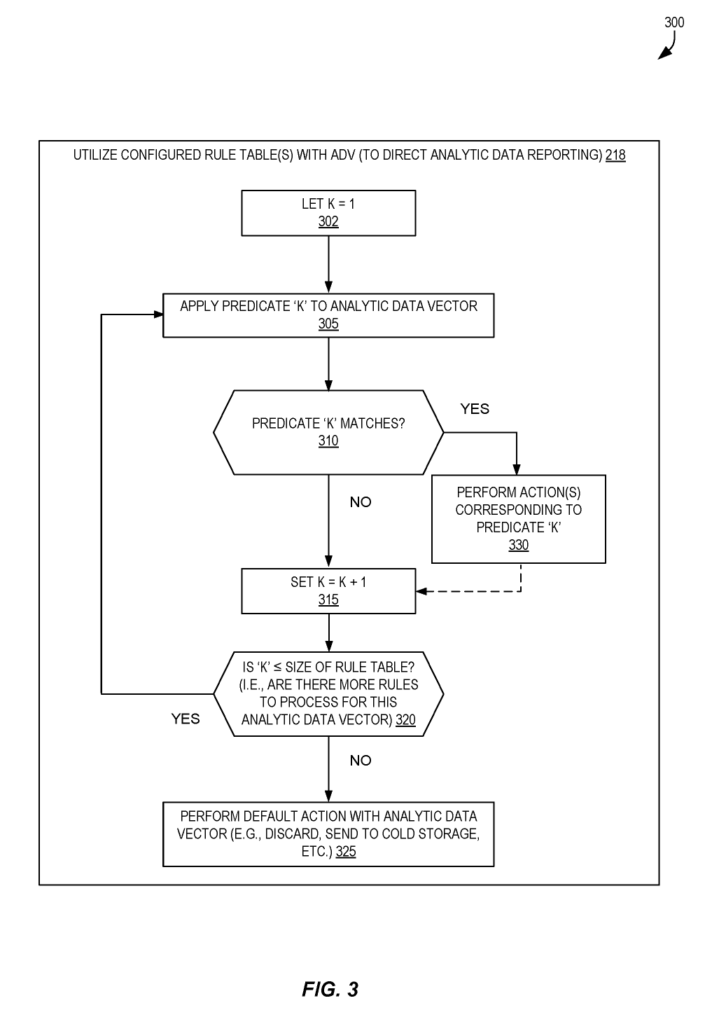

For example, FIG. 3 is a flow diagram illustrating exemplary operations of a flow 300 for utilizing 218 configured rule tables with an analytic data vector (e.g., to direct analytic data reporting) according to some embodiments. The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams. In some embodiments, the operations of flow 300 may be performed by a reporting module 102A as described herein.

At block 302, the flow 300 includes setting a variable “K” to be equal to one. At block 305, the flow 300 includes applying the predicate “K” (i.e., the predicate associated with the Kth rule of the rule table) to the analytic data vector. This application can include, in some embodiments, utilizing one or more values from the analytic data vector, as specified by the predicate, within the condition(s) specified by the predicate to determine whether the predicate evaluates to true (i.e., a “match”) or false (i.e., a “miss”).

At block 310, the flow 300 includes determining whether the Kth predicate was a “match” (i.e., evaluated to true) using the particular analytic data vector values. If so, the flow 300 can continue to block 330 and performing the one or more action(s) corresponding to predicate “K”—i.e., the one or more actions of rule “K.” In various embodiments, there can be a variety of different actions discernable to those of skill in the art that are appropriate in the particular context of use, including but not limited to one or more of forwarding the analytic data vector to the analytics engine 112, forwarding the analytic data vector to cold storage, dropping the analytic data vector, updating a log file to indicate that the analytic data vector matched a rule or the particular rule (e.g., using a rule identifier), generating additional analytic data and sending the additional analytic data (and possibly the original analytic data vector) to the analytics engine 112, etc. In some embodiments, flow 300 may now end, but in other embodiments, the flow 300 may continue on to block 315 and thus, it is possible that the analytic data vector will end up matching multiple predicates (of multiple rules) and that multiple action(s) from multiple rules could be triggered.

When predicate “K” does not match (at block 310), the flow 300 continues to block 315, where the variable “K” is incremented by one, and thus at block 320, it is determined whether this updated “K” value is less than or equal to the size of the rule table (i.e., whether there are additional, unconsidered rules of the rule table remaining to be processed for this analytic data vector). If so, the flow 300 can continue back to block 305, and thus a next predicate of a next rule will be processed, etc. If not, the flow 300 can continue to block 325, where one or more default actions are performed with respect to the analytic data vector. Similar to the action(s) of a rule of the rule table, one or more default actions can be configured for analytic data vectors that do not “match” (the predicate) of any rules, which can include one or more of forwarding the analytic data vector to cold storage, dropping the analytic data vector, updating a log file to indicate that the analytic data vector did not satisfy any rule, etc.

Turning back to FIG. 2, we assume that one of the analytic data vectors (generated at block 214) matched a predicate of a rule that had an action indicating that the analytic data vector should be forwarded (as an analytic report data 122) to the analytics engine 112. At some point in time, then, the reporting module 102 may again perform blocks 214 and 218 (one or more times), as reflected by arrow 219.

At some point in time, the analytics engine 112 may then analyze at block 220 its cache of reported analytic report data (i.e., the zero or more analytic data vectors from zero or more corresponding analytic report data 122). This analysis at block 220 may be performed multiple times based upon a schedule, which can be periodic, aperiodic, or both.

The analysis 220 may utilize different collections of reported analytic report data based upon the particular alerts policies that the analytics engine 112 is configured with. For example, one alerts policy may indicate that certain conditions are to be tested/analyzed using analytic report data from a recent period of time (e.g., 100 milliseconds, 1 second, 1 minute, 5 minutes, 10 minutes, 30 minutes, 1 hour, etc.). Thus, upon an execution of block 220, it is possible that different alerts policies may or may not use different collections of alerts policies to perform the analysis—e.g., one alerts policy may examine a most recent 1 minute of reported analytic report data while another alerts policy (or even another portion of a same alerts policy) may examine a most recent 10 minutes of reported analytic report data.

As a result, one or more alerts policies may be triggered, leading the analytics engine 112 to perform one or more actions associated with those triggered alerts policies, which could include sending an alert event data 132 to the policy engine 110 and/or sending analytics and/or alert event data 133 to any of a variety of destinations. In response to receiving the alert event data 132 sent from the analytics engine 112, the policy engine 110 may perform a responsive action 134A, etc., as described with regard to FIG. 1.

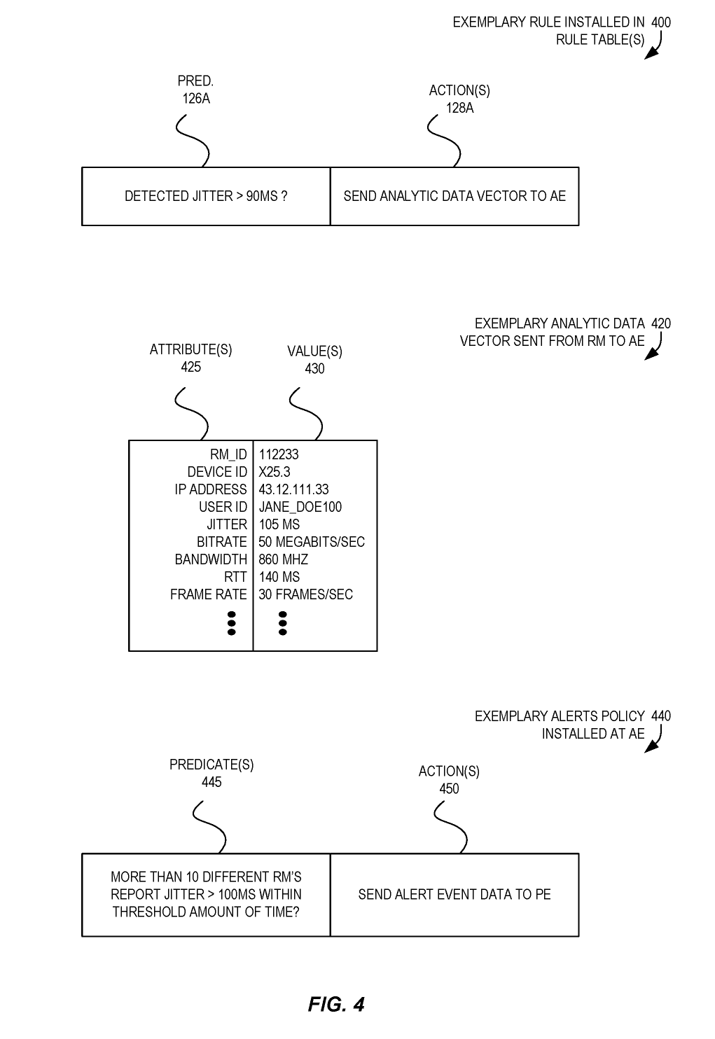

For the purpose of understanding, FIG. 4 illustrates an exemplary rule 400 installed in a rule table 118A, an exemplary analytic data vector 420 sent from a reporting module 102A to an analytics engine 112, and an exemplary alerts policy 440 installed at an analytics engine 112 according to some embodiments.

The exemplary rule 400 is illustrated with one predicate 126A (having one condition) and one action 128A, though there can be more conditions and/or actions in some embodiments. The predicate 126A has a condition of determining whether an observed jitter amount (e.g., the delay variation in the arrival of a set of packets, such as those carrying an IPTV service) is greater than ninety (90) milliseconds. Accordingly, an analytic data vector that can be applied to the predicate 126A will include an observed jitter amount, or will include data that allows for a jitter amount to be determined therefrom. Thus, using the jitter amount from (or derivable from) the analytic data vector, it can be determined whether that jitter amount is greater than or equal to ninety milliseconds. If so, the rule can be thus “matched” or satisfied, and the one or more actions 128A are performed—here, sending the analytic data vector to an analytics engine 112.

The exemplary analytic data vector 420 sent from a reporting module 102 to an analytics engine 112 is illustrated as including a plurality of attributes 425 and a corresponding plurality of values 430, though in other embodiments there can be more, fewer, and/or different attributes and/or values depending upon the context of use.

Notably, the particular attributes 425 utilized can be selected by those of ordinary skill in the art based upon what attribute values are important in a particular context and/or based upon what values can be identified/gathered by a particular reporting module 102. For example, this exemplary analytic data vector 420 includes attributes 425 that are useful in IPTV systems: an identifier of the particular reporting module (RM_ID), an identifier of the device upon which the reporting module is implemented (DEVICE ID), an IP address of the device (IP ADDRESS), an identifier of the user account (of the IPTV system) being utilized at the device (USER ID), an amount of observed jitter (JITTER), an observed bitrate (BITRATE), a utilized bandwidth (BANDWIDTH), an observed round trip time for communications (RTT), an observed frame rate of IPTV content presented by the device (FRAME RATE), etc. Thus, it is to be understood that the types of attributes involved can be selected based upon the context of use of the particular embodiment.

The exemplary alerts policy 440 installed at an analytics engine 112 illustrated in FIG. 4 includes, similar to the exemplary rule 400, one or more predicates 445 and one or more actions 450. In this case, the one or more predicates includes the following condition: are there more than ten (10) different reports from different reporting modules 102 that have been received within a recent threshold amount of time (e.g., 1 minute, etc.) having a reported jitter amount that is greater than 100 milliseconds? If so, the analytics engine 112 can perform the one or more actions 450 of the alerts policy 440: here, generating/sending an alert event data 132 to a policy engine 110.

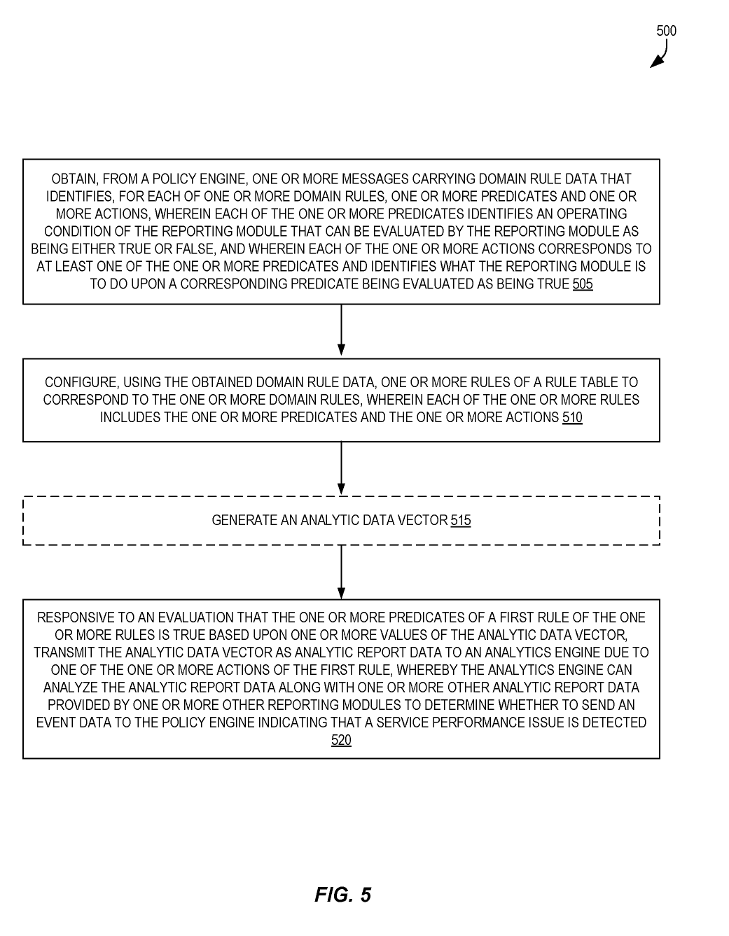

FIG. 5 is a flow diagram illustrating a flow 500 for policy-controlled analytic data collection in large-scale systems according to some embodiments. In some embodiments, the operations of flow 500 may be performed by a reporting module 102A as described herein.

At block 505, the flow 500 includes obtaining, from a policy engine, one or more messages carrying domain rule data that identifies, for each of one or more domain rules, one or more predicates and one or more actions. Each of the one or more predicates identifies an operating condition of the reporting module that can be evaluated by the reporting module as being either true or false, and each of the one or more actions corresponds to at least one of the one or more predicates and identifies what the reporting module is to do upon a corresponding predicate being evaluated as being true.

At block 510, the flow 500 includes configuring, using the obtained domain rule data, one or more rules of a rule table to correspond to the one or more domain rules. Each of the one or more rules includes the one or more predicates and the one or more actions.

At block 515, the flow 500 optionally includes generating the analytic data vector, though in some embodiments the analytic data vector may be obtained from a different entity/module.

At block 520, the flow 500 includes, responsive to an evaluation that the one or more predicates of a first rule of the one or more rules is true based upon one or more values of the analytic data vector, transmitting the analytic data vector as analytic report data to an analytics engine due to one of the one or more actions of the first rule. Accordingly, the analytics engine can analyze the analytic report data along with one or more other analytic report data provided by one or more other reporting modules to determine whether to send an event data to the policy engine indicating that a service performance issue is detected.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

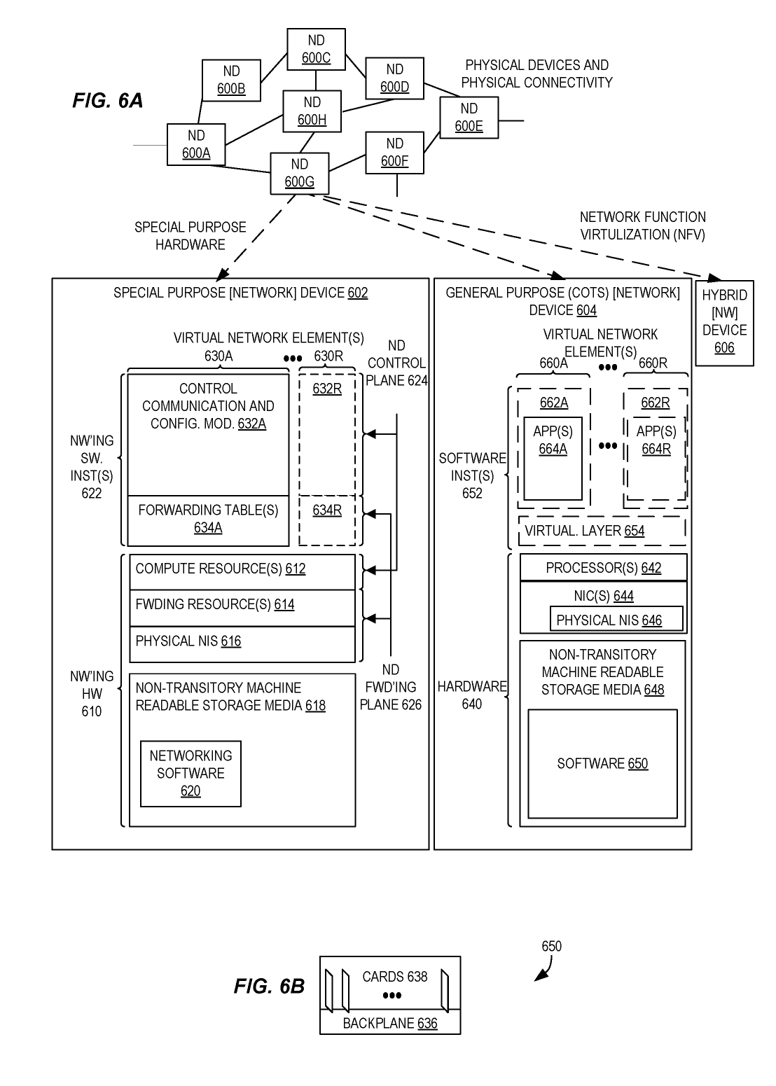

FIG. 6A illustrates connectivity between network devices (NDs) within an exemplary network, as well as three exemplary implementations of the NDs, according to some embodiments of the invention. FIG. 6A shows NDs 600A-H, and their connectivity by way of lines between 600A-600B, 600B-600C, 600C-600D, 600D-600E, 600E-600F, 600F-600G, and 600A-600G, as well as between 600H and each of 600A, 600C, 600D, and 600G. These NDs are physical devices, and the connectivity between these NDs can be wireless or wired (often referred to as a link). An additional line extending from NDs 600A, 600E, and 600F illustrates that these NDs act as ingress and egress points for the network (and thus, these NDs are sometimes referred to as edge NDs; while the other NDs may be called core NDs).

Two of the exemplary ND implementations in FIG. 6A are: 1) a special-purpose network device 602 that uses custom application-specific integrated-circuits (ASICs) and a special-purpose operating system (OS); and 2) a general purpose network device 604 that uses common off-the-shelf (COTS) processors and a standard OS.

The special-purpose network device 602 includes networking hardware 610 comprising compute resource(s) 612 (which typically include a set of one or more processors), forwarding resource(s) 614 (which typically include one or more ASICs and/or network processors), and physical network interfaces (NIs) 616 (sometimes called physical ports), as well as non-transitory machine readable storage media 618 having stored therein networking software 620. A physical NI is hardware in a ND through which a network connection (e.g., wirelessly through a wireless network interface controller (WNIC) or through plugging in a cable to a physical port connected to a network interface controller (NIC)) is made, such as those shown by the connectivity between NDs 600A-H. During operation, the networking software 620 may be executed by the networking hardware 610 to instantiate a set of one or more networking software instance(s) 622. Each of the networking software instance(s) 622, and that part of the networking hardware 610 that executes that network software instance (be it hardware dedicated to that networking software instance and/or time slices of hardware temporally shared by that networking software instance with others of the networking software instance(s) 622), form a separate virtual network element 630A-R. Each of the virtual network element(s) (VNEs) 630A-R includes a control communication and configuration module 632A-R (sometimes referred to as a local control module or control communication module) and forwarding table(s) 634A-R, such that a given virtual network element (e.g., 630A) includes the control communication and configuration module (e.g., 632A), a set of one or more forwarding table(s) (e.g., 634A), and that portion of the networking hardware 610 that executes the virtual network element (e.g., 630A).

The special-purpose network device 602 is often physically and/or logically considered to include: 1) a ND control plane 624 (sometimes referred to as a control plane) comprising the compute resource(s) 612 that execute the control communication and configuration module(s) 632A-R; and 2) a ND forwarding plane 626 (sometimes referred to as a forwarding plane, a data plane, or a media plane) comprising the forwarding resource(s) 614 that utilize the forwarding table(s) 634A-R and the physical NIs 616. By way of example, where the ND is a router (or is implementing routing functionality), the ND control plane 624 (the compute resource(s) 612 executing the control communication and configuration module(s) 632A-R) is typically responsible for participating in controlling how data (e.g., packets) is to be routed (e.g., the next hop for the data and the outgoing physical NI for that data) and storing that routing information in the forwarding table(s) 634A-R, and the ND forwarding plane 626 is responsible for receiving that data on the physical NIs 616 and forwarding that data out the appropriate ones of the physical NIs 616 based on the forwarding table(s) 634A-R.

FIG. 6B illustrates an exemplary way to implement the special-purpose network device 602 according to some embodiments of the invention. FIG. 6B shows a special-purpose network device including cards 638 (typically hot pluggable). While in some embodiments the cards 638 are of two types (one or more that operate as the ND forwarding plane 626 (sometimes called line cards), and one or more that operate to implement the ND control plane 624 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 636 (e.g., a first full mesh coupling the line cards and a second full mesh coupling all of the cards).

Returning to FIG. 6A, the general purpose network device 604 includes hardware 640 comprising a set of one or more processor(s) 642 (which are often COTS processors) and network interface controller(s) 644 (NICs; also known as network interface cards) (which include physical NIs 646), as well as non-transitory machine readable storage media 648 having stored therein software 650. During operation, the processor(s) 642 execute the software 650 to instantiate one or more sets of one or more applications 664A-R. While one embodiment does not implement virtualization, alternative embodiments may use different forms of virtualization. For example, in one such alternative embodiment the virtualization layer 654 represents the kernel of an operating system (or a shim executing on a base operating system) that allows for the creation of multiple instances 662A-R called software containers that may each be used to execute one (or more) of the sets of applications 664A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 654 represents a hypervisor (sometimes referred to as a virtual machine monitor (VMM)) or a hypervisor executing on top of a host operating system, and each of the sets of applications 664A-R is run on top of a guest operating system within an instance 662A-R called a virtual machine (which may in some cases be considered a tightly isolated form of software container) that is run on top of the hypervisor -the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 640, directly on a hypervisor (in which case the unikernel is sometimes described as running within a LibOS virtual machine), or in a software container, embodiments can be implemented fully with unikernels running directly on a hypervisor represented by virtualization layer 654, unikernels running within software containers represented by instances 662A-R, or as a combination of unikernels and the above-described techniques (e.g., unikernels and virtual machines both run directly on a hypervisor, unikernels and sets of applications that are run in different software containers).

The instantiation of the one or more sets of one or more applications 664A-R, as well as virtualization if implemented, are collectively referred to as software instance(s) 652. Each set of applications 664A-R, corresponding virtualization construct (e.g., instance 662A-R) if implemented, and that part of the hardware 640 that executes them (be it hardware dedicated to that execution and/or time slices of hardware temporally shared), forms a separate virtual network element(s) 660A-R.

The virtual network element(s) 660A-R perform similar functionality to the virtual network element(s) 630A-R—e.g., similar to the control communication and configuration module(s) 632A and forwarding table(s) 634A (this virtualization of the hardware 640 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments of the invention are illustrated with each instance 662A-R corresponding to one VNE 660A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 662A-R to VNEs also apply to embodiments where such a finer level of granularity and/or unikernels are used.

In certain embodiments, the virtualization layer 654 includes a virtual switch that provides similar forwarding services as a physical Ethernet switch. Specifically, this virtual switch forwards traffic between instances 662A-R and the NIC(s) 644, as well as optionally between the instances 662A-R; in addition, this virtual switch may enforce network isolation between the VNEs 660A-R that by policy are not permitted to communicate with each other (e.g., by honoring virtual local area networks (VLANs)).

The third exemplary ND implementation in FIG. 6A is a hybrid network device 606, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 602) could provide for para-virtualization to the networking hardware present in the hybrid network device 606.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 630A-R, VNEs 660A-R, and those in the hybrid network device 606) receives data on the physical NIs (e.g., 616, 646) and forwards that data out the appropriate ones of the physical NIs (e.g., 616, 646). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

The NDs of FIG. 6A, for example, may form part of the Internet or a private network; and other electronic devices (not shown; such as end user devices including workstations, laptops, netbooks, tablets, palm tops, mobile phones, smartphones, phablets, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 6A may also host one or more such servers (e.g., in the case of the general purpose network device 604, one or more of the software instances 662A-R may operate as servers; the same would be true for the hybrid network device 606; in the case of the special-purpose network device 602, one or more such servers could also be run on a virtualization layer executed by the compute resource(s) 612); in which case the servers are said to be co-located with the VNEs of that ND.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

While embodiments have been described in relation to an IPTV system, other embodiments can involve different types of large-scale systems. Therefore, embodiments are not limited to IPTV systems.

Additionally, while the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

1. A method in a reporting module implemented by a device for enabling a service performance issue to be detected via policy-controlled analytic data collection, the method comprising:
obtaining, by the reporting module from a policy engine, one or more messages carrying domain rule data that identifies, for each of one or more domain rules, one or more predicates and one or more actions, wherein each of the one or more predicates identifies an operating condition of the reporting module that can be evaluated by the reporting module as being either true or false, and wherein each of the one or more actions corresponds to at least one of the one or more predicates and identifies what the reporting module is to do upon a corresponding predicate being evaluated as being true;
configuring, by the reporting module using the obtained domain rule data, one or more rules of a rule table to correspond to the one or more domain rules, wherein each of the one or more rules includes the one or more predicates and the one or more actions; and
responsive to an evaluation that the one or more predicates of a first rule of the one or more rules is true based upon one or more values of an analytic data vector, transmitting, by the reporting module, the analytic data vector as analytic report data to an analytics engine due to one of the one or more actions of the first rule, whereby the analytics engine can analyze the analytic report data along with one or more other analytic report data provided by one or more other reporting modules to determine whether to send an event data to the policy engine indicating that the service performance issue is detected.

2. The method of claim 1, further comprising generating the analytic data vector.

3. The method of claim 2, further comprising:
after a threshold amount of time, generating a second analytic data vector; and
responsive to an evaluation that at least one of the one or more predicates of the first rule is false, evaluating another one or more predicates of a second rule of the one or more rules.

4. The method of claim 3, further comprising:
responsive to the another one or more predicates of the second rule being evaluated as true, transmitting the second analytic data vector as second analytic report data to the analytics engine.

5. The method of claim 3, further comprising:
responsive to at least one of the another one or more predicates of the second rule being evaluated as false, evaluating the one or more predicates of each additional rule of the one or more rules that has not yet been evaluated; and
responsive to one or more evaluations that at least one of the one or more predicates of each additional rule is false, performing a default action.

6. The method of claim 5, wherein the default action is identified within the domain rule data, and where the default action is not associated with any of the one or more rules.

7. The method of claim 5, wherein the default action comprises causing the second analytic data vector to be stored by a non-volatile storage.

8. The method of claim 1, wherein:
the device is a media player; and
the service comprises an Internet Protocol (IP) television service.

9-13. (canceled)

14. A system to enable a service performance issue to be detected via policy-controlled analytic data collection, comprising:
a policy engine implemented by a first one or more devices;
an analytics engine implemented by a second one or more devices; and
a plurality of reporting modules implemented by a corresponding plurality of devices, wherein the policy engine is to:
receive an alerts policy and one or more predicate-action pairs;
provide the alerts policy to the analytics engine; and
provide domain rule data comprising the one or more predicate-action pairs to each of the plurality of reporting modules;
wherein each of the plurality of reporting modules is to:
configure a rule table that is local to the reporting module to include rules based upon the one or more received predicate-action pairs, wherein each rule includes one or more predicates and one or more corresponding actions to be performed by the reporting module when the one or more predicates evaluate to true;
generate analytic data vectors based upon current characteristics of the device implementing the reporting module; and
transmit, to the analytics engine, one of the analytic data vectors as analytic report data when the one or more predicates of one of the rules evaluate to true based upon the one analytic data vector;
wherein the analytics engine is to:
receive those of the analytic report data that have been transmitted by corresponding ones of the plurality of reporting modules; and
analyze those received analytic report data using the alerts policy to determine when to transmit an event data to the policy engine indicating that the service performance issue is detected.

15. The system of claim 14, wherein each of the plurality of devices is a media player.

16. The system of claim 14, wherein the one of the analytic data vectors includes at least two of:
a network address of the device implementing the reporting module;
a jitter value;
a bitrate;
a bandwidth;
a round trip time (RTT); or
a frame rate.

17. The system of claim 14, wherein the alerts policy indicates that the event data is to be transmitted to the policy engine when a threshold number of the plurality of reporting modules has transmitted an analytic data vector due to a common one or more predicates evaluating to true, wherein the threshold number is greater than one.

18. A non-transitory machine-readable storage medium having instructions which, when executed by one or more processors of a device, cause the device to implement a reporting module to perform operations for implementing policy-controlled analytic data collection to enable a service performance issue to be detected, the operations comprising:
obtaining, by the reporting module from a policy engine, one or more messages carrying domain rule data that identifies, for each of one or more domain rules, one or more predicates and one or more actions, wherein each of the one or more predicates identifies an operating condition of the reporting module that can be evaluated by the reporting module as being either true or false, and wherein each of the one or more actions corresponds to at least one of the one or more predicates and identifies what the reporting module is to do upon a corresponding predicate being evaluated as being true;
configuring, by the reporting module using the obtained domain rule data, one or more rules of a rule table to correspond to the one or more domain rules, wherein each of the one or more rules includes the one or more predicates and the one or more actions; and
responsive to an evaluation that the one or more predicates of a first rule of the one or more rules is true based upon one or more values of an analytic data vector, transmitting, by the reporting module, the analytic data vector as analytic report data to an analytics engine due to one of the one or more actions of the first rule, whereby the analytics engine can analyze the analytic report data along with one or more other analytic report data provided by one or more other reporting modules to determine whether to send an event data to the policy engine indicating that the service performance issue is detected.

19. The non-transitory machine-readable storage medium of claim 18, wherein the operations further comprise generating the analytic data vector.

20. The non-transitory machine-readable storage medium of claim 19, wherein the operations further comprise:
after a threshold amount of time, generating a second analytic data vector; and
responsive to an evaluation that at least one of the one or more predicates of the first rule is false, evaluating another one or more predicates of a second rule of the one or more rules.

21. The non-transitory machine-readable storage medium of claim 20, wherein the operations further comprise:
responsive to the another one or more predicates of the second rule being evaluated as true, transmitting the second analytic data vector as second analytic report data to the analytics engine.

22. The non-transitory machine-readable storage medium of claim 20, wherein the operations further comprise:
responsive to at least one of the another one or more predicates of the second rule being evaluated as false, evaluating the one or more predicates of each additional rule of the one or more rules that has not yet been evaluated; and
responsive to one or more evaluations that at least one of the one or more predicates of each additional rule is false, performing a default action.

23. The non-transitory machine-readable storage medium of claim 22, wherein the default action is identified within the domain rule data, and where the default action is not associated with any of the one or more rules.

24. The non-transitory machine-readable storage medium of claim 22, wherein the default action comprises causing the second analytic data vector to be stored by a non-volatile storage.

25. The non-transitory machine-readable storage medium of claim 18, wherein:
the device is a media player; and
the service comprises an Internet Protocol (IP) television service.
